(19) United States
(12) Patent Application Publication
(10) Pub. No.: US 2024/0308604 A1
(43) Pub. Date: Sep. 19, 2024

(54) VEHICLE WITH TRACK WIDTH ADJUSTMENT

(71) Applicant: Pfanzelt Maschinenbau GmbH, Rettenbach (DE)

(72) Inventor: Paul PFANZELT, Rettenbach (DE)

(21) Appl. No.: 18/581,807

(22) Filed: Feb. 20, 2024

(30) Foreign Application Priority Data
Mar. 17, 2023 (DE) 10 2023 106 771

(51) Int. Cl. B62D 55/084; B62D 21/14; F15B 15/14

(52) U.S. Cl. CPC B62D 55/084; B62D 21/14; F15B 15/1457

(57) ABSTRACT

The vehicle according to the invention has a frame, a first running gear and a second running gear, wherein the two running gears are arranged on opposite sides of the frame and are mounted so as to be displaceable relative to the frame by means of hydraulic cylinders for changing the track width. Each hydraulic cylinder here includes a component fixed to the frame and a component which can be displaced relative to the frame, wherein the first and second running gears are each fastened to the displaceable component of the hydraulic cylinders, and the displaceable component of the hydraulic cylinders is displaceably guided in a guide on the frame, wherein the guide is designed to transmit forces between the displaceable component and the frame transversely to the displacement direction of the displaceable component.

Track-width adjustable vehicles are used, for example, in forestry and agriculture. The vehicles can usually be coupled to different attachments, wherein, for example, this can be a cable winch for assistance in the case of felling jobs or logging, equipment for the preparation and care of plants such as mulching, sowing, chipping or the like. The option of changing the track width ensures that the vehicle has a secure footing even on difficult terrain.

EP 3 606 629 B1 discloses a radio-controlled vehicle which has a first and a second running gear, wherein the two running gears are arranged on opposite sides of a frame. Each running gear has two spaced-apart rectangular tubes which are guided so as to be displaceable in a guide tube fixedly mounted on the frame. The track width is adjusted via hydraulic cylinders which cause a displacement of the running gear relative to the frame.

A similar design is disclosed in DE 10 2011 102 110 A1, wherein a running gear for a crawler crane has a central frame part and a left and right chain tracks, wherein each chain track has two supports, and the supports are displaceably mounted on the central frame part. For each movably mounted support, the central frame part has a separate recess for displaceably holding the supports. For adjusting the track width, each chain track is assigned hydraulic cylinders which are arranged in the interior of the central frame part in the region of the slewing ring.

From DE 42 10 532 A1 and DE 20 47 480 A, further running gears with lane width adjustment are known.

Proceeding from this, the object of the invention was to provide a more economical option for the track width adjustment.

According to the invention, this object is achieved by the features of claim 1.

The vehicle according to the invention has a frame, a first running gear and a second running gear, wherein the two running gears are arranged on opposite sides of the frame and are mounted so as to be displaceable relative to the frame by means of hydraulic cylinders for changing the track width. Each hydraulic cylinder here comprises a component fixed to the frame and a component which can be displaced relative to the frame, wherein the first and second running gears are each fastened to the displaceable component of the hydraulic cylinders, and the displaceable component of the hydraulic cylinders is displaceably guided in a guide on the frame, wherein the guide is designed to transmit forces between the displaceable component and the frame transversely to the displacement direction of the displaceable component.

According to the invention, the displaceable components of the hydraulic cylinders therefore not only have the task of generating or absorbing forces in the direction of the cylinder axis, but also have the function of transmitting forces transversely to the displacement direction of the displaceable component and therefore also serve to transmit the forces between the frame and the running gears.

According to a further aspect of the invention, each of the two running gears is connected to the frame via a front and a rear support element, wherein the front and rear support elements are displaceably guided in a guide on the frame in order to be able to adjust different track widths. For changing the track width, hydraulic cylinders are used which have a component fixed to the frame and a component that can be displaced relative to the frame. The support elements primarily have the task of transmitting the forces between the frame and the running gears and vice versa, while the hydraulic cylinders are usually only provided for adjusting the track width. According to the invention, however, the hydraulic cylinders are designed and arranged such that they replace at least individual support elements physically and functionally, in that each hydraulic cylinder has a component fixed to the frame and a component which can be displaced relative to the frame, wherein the first and second running gear are each fastened to the displaceable component of the hydraulic cylinders, and the displaceable component of the hydraulic cylinders is displaceably guided in a guide on the frame, and the guide is designed to transmit forces between the displaceable component and the frame transversely to the displacement direction of the displaceable component.

In a first embodiment according to the invention, all support elements are replaced by corresponding hydraulic cylinders, whereas in a second embodiment, either only the front or only the rear support elements are formed by corresponding hydraulic cylinders.

Further embodiments of the invention are the subject matter of the dependent claims.

According to a preferred embodiment of the invention, the guide in the frame is a guide bore which is in direct guiding contact with an outer peripheral surface of the displaceable component. If the component fixed to the frame is formed by a piston rod and the displaceable component is formed by a cylinder pushed onto the piston rod, good stability of the connection of the running gears to the frame is ensured. Viewed in the direction of travel of the vehicle, each running gear is ideally attached to the frame by at least one front and/or at least one rear hydraulic cylinder. For example, two separate front hydraulic cylinders can be provided, wherein the one front hydraulic cylinder is connected to the first running gear, and the second front hydraulic cylinder is connected to the second running gear. In a corresponding manner, two separate rear hydraulic cylinders can also be connected to the first or second running gear.

Within the scope of the invention, however, it is particularly advantageous if the two front hydraulic cylinders are formed by a component fixed to the frame and two displaceable components which are pushed on or in at opposite ends of the fixed component, and the first running gear is fastened to one displaceable component and the second running gear is fastened to the other displaceable component. Here too, particularly good stability results when the component fixed to the frame is formed by a coupling rod, and the two displaceable components are formed by pushed-on cylinders. In this way, the two rear hydraulic cylinders can also be formed by a component fixed to the frame and two displaceable components.

The displacement distance of the displaceable component can be limited by a stop element in order to limit the maximum adjustable track width. The hydraulic cylinders are preferably designed as double-acting hydraulic cylinders in order to be able to effect an adjustment in the sense of an increase in the track width and, on the other hand, in the sense of a reduction of the track width. To enable the relative displaceability and the force transmission between the cylinder and the piston rod, (axially) spaced-apart guide elements and (axially) spaced seals are provided. A first pressure chamber can be formed between a front end of the piston rod and a sealed end region of the cylinder. A second pressure chamber is delimited by the spaced-apart seals, an inner wall of the cylinder, and a peripheral surface of the piston rod. Furthermore, a first pressure medium channel, which is in fluidic communication with the first pressure chamber, and a second pressure medium channel which is in fluidic communication with the second pressure chamber can be provided in the interior of the piston rod, wherein the first pressure medium channel and the second pressure medium channel have a pressure medium connection at the end facing away from the first or second pressure chamber. This results in a particularly compact device for adjusting the track width.

The running gears are preferably designed as a track running gear or wheeled running gear. In order to enable a wide variety of use of the vehicle, different attachments can be coupled depending on the intended use. This can be, for example, a cable winch for assistance in the case of felling jobs or logging, equipment for the preparation and care of plants such as mulching, sowing, chipping or the like. A particularly compact vehicle can be achieved if the vehicle is remotely controllable, and a driver's cab or a vehicle cab can therefore be dispense with.

Each running gear can also have a suitable drive motor, such as an oil motor or an electric motor. A power source (battery) connected to the drive motors of the running gears or also the motor itself can, however, also be provided in the frame.

An exemplary embodiment of the invention is described in greater detail with reference to the following description and the drawing.

In the drawings:

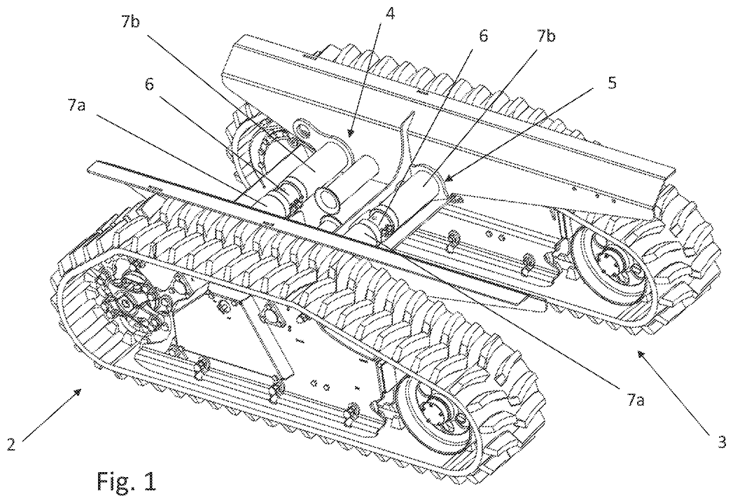

FIG. 1 shows a three-dimensional representation of the vehicle according to the invention according to a first exemplary embodiment,

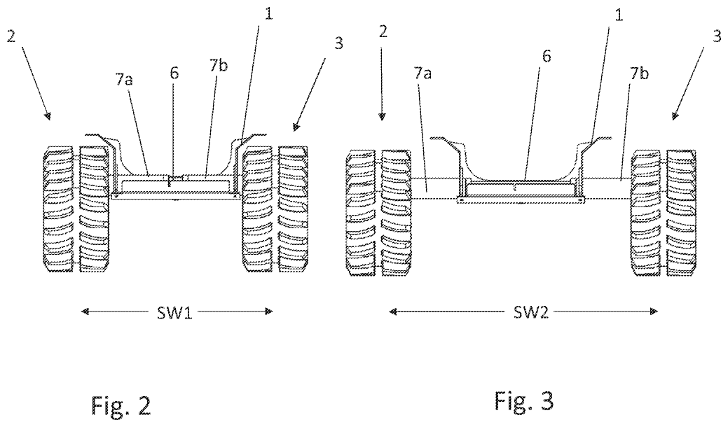

FIG. 2 shows a rear view of the vehicle according to FIG. 1 with a narrow lane width adjustment,

FIG. 3 shows a rear view of the vehicle according to FIG. 1 with a wide lane width adjustment,

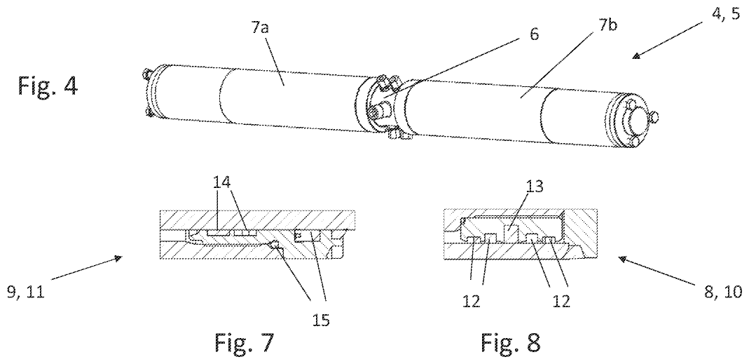

FIG. 4 shows a three-dimensional representation of the hydraulic cylinder,

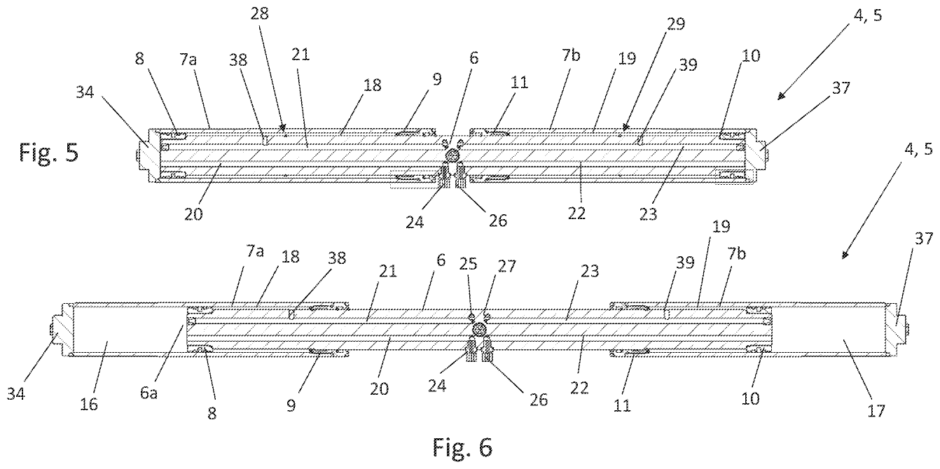

FIG. 5 shows a longitudinal sectional view of the hydraulic cylinder in the narrow track width adjustment,

FIG. 6 shows a longitudinal sectional view of the hydraulic cylinder in the wide track width adjustment,

FIG. 7 shows a detailed sectional view in the region of a first guide bush,

FIG. 8 shows a detailed sectional view in the region of a second guide bush,

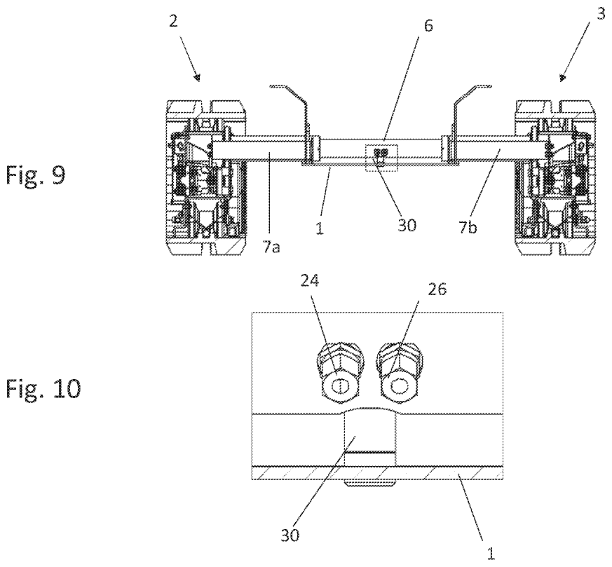

FIG. 9 shows a rear view of the vehicle with a sectional representation of the running gears,

FIG. 10 shows a detailed view in the region of the fixation of the fixed component on the frame,

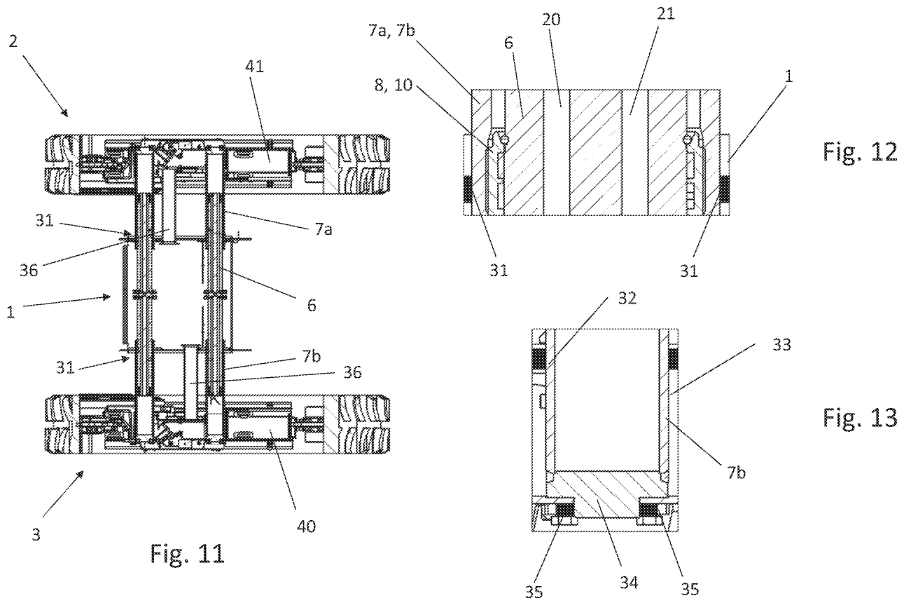

FIG. 11 shows a partially cutaway plan view of the vehicle,

FIG. 12 shows a sectional view in the region of the guide of the hydraulic cylinder on the frame,

FIG. 13 shows a sectional view in the region of the fastening of the hydraulic cylinder to the running gear,

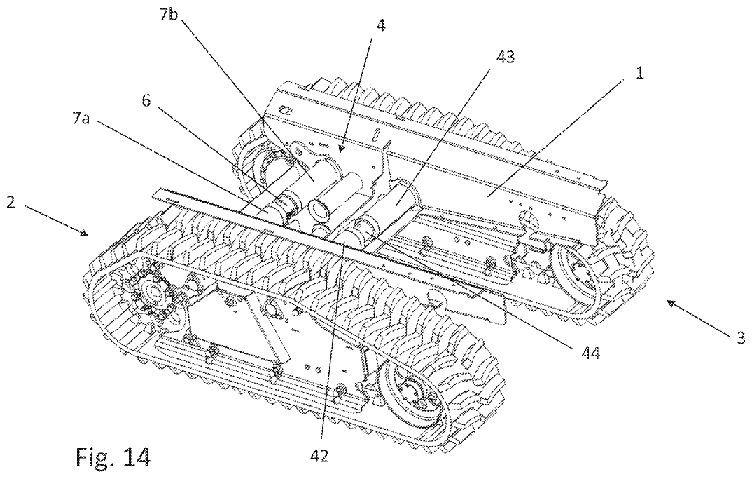

FIG. 14 shows a three-dimensional representation of the vehicle according to the invention according to a second embodiment,

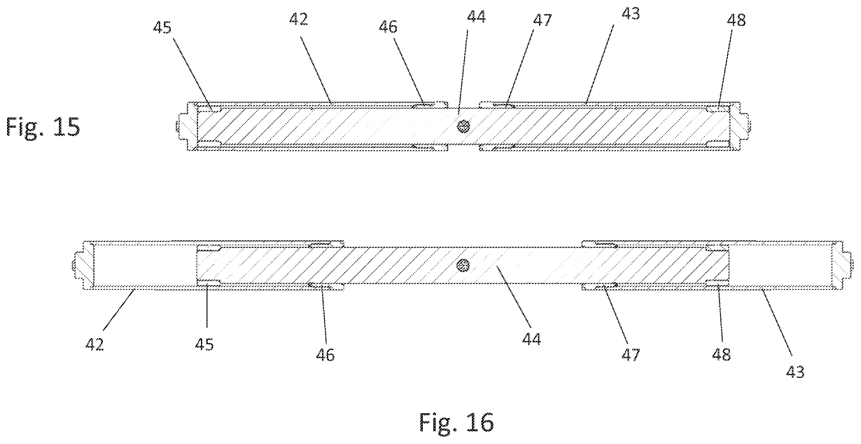

FIG. 15 shows a longitudinal sectional view of the support element in the narrow lane width adjustment, and

FIG. 16 shows a longitudinal sectional view of the support element in the wide track width adjustment.

The first exemplary embodiment of a vehicle according to the invention shown in FIG. 1 has a frame 1, a first running gear 2 and a second running gear 3, wherein the two running gears 2, 3 are designed as crawler tracks and are arranged on opposite sides of the frame 1. It can be seen from FIGS. 2 and 3 that the running gears 2 and 3 are mounted so as to be displaceable relative to the frame 1 for changing the track width SW1, SW2. The distance between the center of the two running gears 1, 2 is regarded here as the track width. FIG. 2 shows the vehicle with a narrow track width SW1, whereas in FIG. 3, a wide track width SW2 is adjusted.

The track width adjustment takes place via a front hydraulic cylinder 4 and a rear hydraulic cylinder 5, wherein each of the two hydraulic cylinders 4, 5 comprises a component 6 fixed to the frame 1, and a first component 7a displaceable relative to the frame 1, and a second component 7b displaceable relative to the frame 1. In the shown embodiment, the component 6 fixed to the frame 1 is formed by a coupling rod, while the two displaceable components 7a, 7b are formed by cylinders pushed onto opposite ends of the coupling rod. The front hydraulic cylinder 4 and the rear hydraulic cylinder 5 therefore each use a common coupling rod as a fixed component 6, onto which the two displaceable components 7a, 7b designed as cylinders are pushed.

The first running gear 2 is in each case fastened to the first displaceable component 7a of the front or rear hydraulic cylinder 4 or 5, while the second running gear 3 is coupled to the second displaceable components 7b of the front or rear hydraulic cylinder 4 or 5 (FIGS. 1 to 3).

The front and rear hydraulic cylinders 4, 5 are designed identically in the shown exemplary embodiment and are described in more detail below with reference to FIGS. 4 to 8.

Both hydraulic cylinders 4, 5 are designed as double-acting hydraulic cylinders, wherein two spaced-apart guide bushes 8, 9 or 10, 11 are provided in each case for relative displaceability and for force transmission between the first or second displaceable component 7a or 7b (cylinder) and the fixed component 6 (coupling rod), wherein the guide bushes 8 and 10 (FIG. 8) are each pressed onto the opposite ends of the fixed component 6 while the guide bushes 9 and 11 (FIG. 7) are each fixed at the pushed-on end of the first or second displaceable component 7a, 7b.

The guide bushes 8 and 10 are each provided with guide elements 12 and seals 13. In a corresponding manner, the guide bushes 9 and 11 provide guide elements 14 and seals 15 in order on the one hand to ensure the sliding displaceability between the fixed component 6 and the two displaceable components 7a, 7b and, on the other hand, to enable the formation of the pressure chambers described below.

Each side of the hydraulic cylinders 4, 5 has a first pressure chamber 16 or 17 and a second pressure chamber 18 or 19 which can be acted upon by a suitable pressure medium, in particular oil, for displacing the displaceable components 7a, 7b via first pressure medium channels 20, 22 or second pressure medium channels 21, 23 arranged in the fixed component 6 and associated pressure medium connections 24, 25, 26, 27. The first pressure chamber 16 or 17 is delimited by the front end 6a of the fixed component 6, the inner wall of the displaceable components 7a, 7b, and a closure element 34 or 37 terminating the displaceable components 7a, 7b, and the seals 13. The second pressure chamber 18 or 19 is formed by the outer peripheral surface of the fixed component 6, the inner wall of the first or second displaceable component 7a, 7b and by the spaced-apart seals 13, 15.

A application of pressure medium in the first pressure chamber 16 or 17 leads to the extension of the displaceable components 7a, 7b and therefore brings about an increase in the track width. The track width is readjusted or reduced by pressurizing the second pressure chambers 18 or 19. For this purpose, the second pressure chambers 18, 19 are connected to the second pressure channels 21 and 23 via short transverse bores 38, 39. In the shown exemplary embodiment, the two sides can be controlled separately from one another so that only one of the two running gears 2, 3 could optionally also be adjusted relative to the frame. However, it would also be conceivable for the two pressure medium channels 20 and 22 or 21 and 23 to be able to be pressurized jointly via an associated connection in order to thereby exclusively bring about a common adjustment.

To limit the maximally extendable distance of the displaceable components 7a, 7b, stop elements 28 and 29 are provided which are arranged in the outer wall of the fixed component 6 and form a stop for the displaceable component 7a or 7b in the region of the guide bushes 9 or 11.

In the shown exemplary embodiment, the fixed component 6 has a centrally arranged fastening pin 30 which serves to fix the component 6 to the frame 1 and is in particular screwed there (FIG. 9, 10).

In the following, the guidance of the hydraulic cylinders 4, 5 on the frame 1 and the fastening of the running gears 2, 3 to the hydraulic cylinders 4, 5 will be explained in more detail with reference to FIGS. 11 to 13.

The displaceable components 7a, 7b of the hydraulic cylinders 4, 5 are guided in a displaceable manner in a guide 31 on the frame 1, wherein the guide is designed to transmit forces between the displaceable component 7a or 7b and the frame 1 transversely to the displacement direction of the displaceable component 7a, 7b. In the shown embodiment according to FIG. 12, the guide 31 is a guide bore formed in the frame 1 and is in direct guide contact with the outer peripheral surface of the displaceable component 7a or 7b. The two hydraulic cylinders 4, 5 therefore project through the guide bores 31 on both sides of the frame 1. In this way, a simple but stable design for adjusting the track width is achieved by correspondingly designed tolerances.

The running gears 2, 3 are fastened to the ends of the displaceable components 7a, 7b according to FIG. 13 projecting from the frame 1. For this purpose, the displaceable components 7a, 7b are provided with end elements 34 or 37 at their ends projecting out of the frame and are inserted with these ends through precisely fitting openings 32 into the running gear frame 33 of the respective running gears 2, 3, where they are fixed to the running gear frame 33 by means of screws 35 in the region of the terminating elements 34 or 37.

Each running gear 2, 3 preferably has a separate drive motor 40, 41 which is formed, for example, by an oil motor or an electric motor. The power source (hydraulic pump, battery) required for this purpose is then expediently arranged in the frame 1 (not shown) and is in connection in a suitable manner with the drive motors 40, 41 of the running gears 2, 3. Any connecting lines (oil lines, electric cables) between the frame 1 and the corresponding running gears 2, 3 are guided between the power source and the drive motors 40, 41, for example, by connecting tubes 36 (FIG. 11).

While the frame 1 is only supported by the hydraulic cylinders 4, 5 on the first running gear 2 and the second running gear 3 in the previously described exemplary embodiment, FIGS. 14 to 16 show a second exemplary embodiment in which, instead of the rear (alternatively to the front) hydraulic cylinder, displaceable bearing elements 42, 43 are provided.

Otherwise, the vehicle correspondingly has a frame 1, a first running gear 2, and a second running gear 3, wherein the two running gears 2, 3 are designed as crawler tracks and are arranged on opposite sides of the frame 1. The track width adjustment takes place via the front hydraulic cylinders 4, which are designed according to the first embodiment, and therefore comprise a component 6 fixed to the frame 1 and a first component 7a displaceable relative to the frame 1 and a second component 7b displaceable relative to the frame 1.

Corresponding to the first exemplary embodiment, the component 6 fixed to the frame 1 is also formed by a coupling rod, while the two displaceable components 7a, 7b are formed by cylinders pushed onto opposite ends of the coupling rod. The front hydraulic cylinders 4 therefore each use a common coupling rod as a fixed component 6, onto which the two displaceable components 7a, 7b designed as cylinders are pushed. In addition, the first running gear 2 is in turn fastened to the first displaceable component 7a, while the second running gear 3 is coupled to the second displaceable component 7b (FIG. 14). The front hydraulic cylinders 4 correspond to the hydraulic cylinders described in FIGS. 4 to 8 of the first exemplary embodiment.

The displaceable support elements 42, 43 are displaceably mounted on the frame 1 in order to realize the track width adjustment. For this purpose, correspondingly designed recesses can be provided in the frame 1, wherein suitable guides prevent tilting or jamming of the support elements. The displaceable support elements 42, 43 can have any suitable cross-sectional shape, in particular round or rectangular. In the shown exemplary embodiment, the displaceable support elements 42, 43 are designed similarly to the displaceable components 7a, 7b. In addition, a support part 44 fixed to the frame 1 is provided and is designed like a coupling rod similar to the fixed component 6, while the two displaceable support elements 42, 43 are formed by cylinders pushed onto opposite ends of the fixed support part 44. The first running gear 2 is connected to the first displaceable support element 42, while the second running gear 3 is coupled to the second displaceable support element 43.

For relative displaceability and for force transmission between the first or second displaceable support element 42, 43 and the fixed support part 44, two spaced-apart guide bushes 45, 46 or 47, 48 are provided in each case, wherein the guide bushes 45 and 48 (FIG. 15, 16) are each pressed onto the opposite ends of the fixed support part 44, while the guide bushes 46 and 47 (FIG. 15, 16) are each fixed to the pushed-on end of the first or second displaceable support part 42, 43.

The difference from the hydraulic cylinders shown in FIGS. 5 and 6 is only that the fixed support part 44 does not have pressure medium channels and pressure medium connections. The guiding of the displaceable support elements 42, 43 on the frame 1 and the fastening of the running gears 2, 3 to the support elements 42, 43 takes place analogous to the guiding of the hydraulic cylinders 4, 5 on the frame 1 shown in FIGS. 11 to 13 and the fastening of the running gears 2, 3 to the hydraulic cylinders 4, 5.

1. A vehicle having a frame (1), a first running gear (2) and a second running gear (3), wherein the two running gear (2, 3) are arranged on opposite sides of the frame (1) and are mounted so as to be displaceable relative to the frame (1) by means of hydraulic cylinders (4, 5) for changing the track width, wherein each hydraulic cylinder (4, 5) comprises a component (6) fixed to the frame and at least one component (7a, 7b) which can be displaced relative to the frame (1), and the first and second running gear (2, 3) are each fastened to the displaceable component (7a, 7b) of the hydraulic cylinders (4, 5),
characterized in that the displaceable component (7a, 7b) of the hydraulic cylinders (4, 5) is guided so as to be displaceable in a guide (31) on the frame (1), wherein the guide is designed to transmit forces between the displaceable component (7a, 7b) and the frame (1) transversely to the displacement direction of the displaceable component (7a, 7b).

2. The vehicle according to claim 1, characterized in that the guide (31) in the frame (1) is a guide bore which is in direct guiding contact with an outer peripheral surface of the displaceable component (7a, 7b).

3. The vehicle according to claim 1, characterized in that the component (6) fixed to the frame (1) is formed by a piston rod, and the displaceable component (7a, 7b) is formed by a cylinder pushed onto the piston rod.

4. The vehicle according to claim 3, characterized in that a stop element (28, 29) is provided for limiting the displacement distance of the displaceable component (7a, 7b).

5. The vehicle according to claim 1, characterized in that the hydraulic cylinders are formed by at least one front and at least one rear hydraulic cylinder (4, 5), viewed in the direction of travel of the vehicle.

6. The vehicle according to claim 5, characterized in that the front and rear hydraulic cylinders (4, 5) are each formed by a component (6) fixed to the frame (1) and two displaceable components (7a, 7b) which are pushed on or into open at opposite ends of the fixed component (6), and the first running gear (2) is fastened to one displaceable component (7a) and the second running gear (3) is fastened to the other displaceable component (7b).

7. The vehicle according to claim 6, characterized in that the component (6) fixed to the frame (1) is formed by a coupling rod, and the two displaceable components (7a, 7b) are formed by pushed-on cylinders.

8. The vehicle according to claim 3, characterized in that the hydraulic cylinders (4, 5) are designed as double-acting hydraulic cylinders, wherein guide elements (12, 14), which are spaced apart for relative displaceability and for force transmission between the cylinder and the piston rod, and spaced-apart seals (13, 15) are provided, wherein a first pressure chamber (16, 17) is formed between a front end of the piston rod and a sealed off end region of the cylinder, and a second pressure chamber (18, 19) is delimited by the two spaced-apart seals (13, 15), an inner wall of the cylinder, and a peripheral surface of the piston rod.

9. The vehicle according to claim 8, characterized in that a first pressure medium channel (20, 22), which is in fluidic communication with the first pressure chamber (16, 17), and a second pressure medium channel (21, 23), which is in fluidic communication with the second pressure chamber (18, 19), are provided in the interior of the piston rod, wherein the first pressure medium channel (20, 22) and the second pressure medium channel (21, 23) have a pressure medium connection (24-27) at the end facing away from the first or second pressure chamber (16, 17; 18, 19).

10. The vehicle according to claim 1, characterized in that it is a remotely controlled vehicle for coupling at least one attachment.

11. The vehicle according to claim 1, characterized in that the first and the second running gear (2, 3) are a track running gear or a wheeled running gear.

12. The vehicle according to claim 1, characterized in that each running gear (2, 3) has a drive motor.

13. The vehicle according to claim 12, characterized in that at least one energy source connected to the drive motors of the running gear (2, 3) is provided in the frame (1).

14. The vehicle according to claim 1, characterized in that each of the two running gears (2, 3) is connected to the frame (1) via a front and a rear support element, wherein the front and rear support elements are guided in a guide on the frame so as to be displaceable in order to be able to adjust different track widths, and wherein the hydraulic cylinders are designed and arranged such that they replace the front and/or rear support elements physically and functionally.
